(19) United States
(12) Patent Application Publication
(10) Pub. No.: US 2014/0114221 A1
(43) Pub. Date: Apr. 24, 2014

(54) ADJUSTABLE HANDHELD ROLLER MASSAGE APPARATUS WITH FABRIC-COVERED RESILIENT AIR-FILLED SPHERICAL CONTACT ORBS

(71) Applicants: Kathy L. Indermill, Oceanside, CA (US); Basil P. Indermill, Oceanside, CA (US)

(72) Inventors: Kathy L. Indermill, Oceanside, CA (US); Basil P. Indermill, Oceanside, CA (US)

(21) Appl. No.: 13/657,690

(22) Filed: Oct. 22, 2012

(51) Int. Cl. A61H 15/00

(52) U.S. Cl. CPC A61H 15/0092
USPC 601/120

(57) ABSTRACT

Handheld roller massage apparatus comprising at least two air-filled elastomeric massage spheres and two handle grips attached to a support rod where the handle grips and massage spheres are fully adjustable along the support rod. Massage spheres have special size, elastic modulus, and perceived inflation pressure to reach deep muscle and ligament tissue along either side of the spine. Massage spheres deform from massage pressure primarily in the tip of the sphere and not at the base due to support from T-washer members on either side of massage spheres, which also helps reach deep muscle and ligament tissue along either side of the spine.

### CROSS-REFERENCE TO RELATED APPLICATIONS

The instant application claims the benefit of priority to U.S. Provisional Patent Application Ser. No. 61/549,889, filed on Oct. 21, 2011, entitled “GripNRoll”, which is hereby incorporated by reference herein.

### BACKGROUND OF THE INVENTION

1. Field of the Invention

This invention relates to a handheld roller massage apparatus used to massage a target area on the exterior human body; and, more specifically, used to massage and stimulate deep muscle and ligament tissue located far beneath the skin and especially such tissue located on either side of the spine.

2. Description of Related Art

An inventor of this invention has scoliosis, which is a disease that causes a curvature of the spine. This disease is exasperated with the inventor because she also has one leg that is one-half inch shorter than the other leg, and this discrepancy has caused extended curvature in her spine. As a result of these conditions, the inventor experiences relentless pain at the end of her tailbone along with abdominal pain, knee pain, back pain, and other aches and pains throughout the body. To combat this, doctors and chiropractors suggested the use massage techniques and massage apparatuses to loosen and retrain tight muscles and ligaments in the back in order to reduce the pain and possibly even help straighten her spine as a result of muscle retraining. Following these suggestions, the inventors tried many prior art massage techniques and devices designed to reduce muscle and ligament pain only to find that the techniques and devices did not materially improve the condition or reduce pain.

Consequently, applicants set out to develop their own massage device. Working together, applicants have designed a handheld roller massage apparatus that is the culmination of such research and development and represents significant improvement in the realm of handheld roller massage apparatuses.

There are numerous handheld roller massage apparatus designs in the prior art. The basic design is similar to that of a rolling pin: a center dowel, one handle attached to each end of the dowel, and a roller member pivotally attached to the dowel between the handles. Handheld roller massage apparatuses are used to roll or massage a target area on the body. Users hold the handheld roller massage apparatus with one hand on each handle and press down on the dowel and roll over the target area, thereby applying pressure to the target area, in a similar fashion to rolling out dough with a rolling pin.

This invention is a handheld roller massage apparatus with the following novel characteristics. Handheld roller massage apparatus comprises a rigid cylindrical metal tube or support rod about 1.5-4 feet long and about 0.25-2 inches in outer diameter. Support rod will not deflect or bend under 200 pounds or less of pressure on each end. Handheld roller massage apparatus further comprises two handles and at least two contact orbs.

Handheld roller massage apparatus provides complete adjustability in that each handle and each contact orb may be individually adjusted to any position along the length of a rigid cylindrical metal tube. Complete adjustability is required to adjust the position of contact orbs to match the actual and specific separation distance of the patient's deep muscle tissue beneath the skin adjacent to the patient's spine and also to adjust to the specific separation distance of the person's hands delivering the massage to the desired distance to allow for the massager to more comfortably apply the required pressure to massage and stimulate the target muscle tissue. Adjustability of the orbs provides the ability to target the correct areas regardless of the particular patient's spine size. Adjustability of the handles provides the ability for the massager to comfortably apply enough pressure to reach deep tissue regardless of the person's size. Without these capabilities, to a certain degree, each handheld roller massage apparatus needs to be specially sized and manufactured for each patient and also for each person delivering the massage in order to properly target the specific areas to initiate deep tissue massage and stimulation along the spine, as does this invention.

Handheld roller massage apparatus includes contact orbs that are spherically shaped with an outer diameter of 2.5 to 3 inches. The human spine or backbone consists of many smaller bones or vertebrae connected together by ligament and muscle tissue like rungs on a ladder. With this analogy, the vertebrae in the spine are the rungs and the side rails of the ladder are the muscles and ligaments holding the rungs together. This simplified model is not completely accurate because the muscle and ligament tissue that hold the vertebrae together actually loop and wind around the vertebrae repeatedly rather than run straight through, as do the rails on a ladder. Additionally, there are many more that two ligaments or muscles running down the length of the spine; in fact, there are over thirty muscles alone running down the spinal column, holding vertebrae together. Further, muscle and ligaments form a swirling corkscrew mass of tentacles looping and corkscrewing around both sides of the vertebrae in the spinal column. As a result, in order to massage, compress, or agitate the muscles and ligaments near the bottom of this swirling corkscrew mass, it becomes necessary for contact orbs on a massage apparatus to push down on the skin and press down below the surface of the skin in order to massage, compress, or agitate muscles and ligaments below the skin surface.

Handheld roller massage apparatus includes hollow spherical contact orbs made of thin walled semi-rigid resilient material with an elastic modulus within a narrow range so that contact orbs do not appreciably deflect or deform with less than 10 pounds of pressure applied but do deflect and deform somewhat with 10 pounds of pressure or more applied, and deflect and deforms readily with 40 pounds of pressure or more applied. Applicants have determined that contact orbs within this range of resiliency deliver tissue massage and stimulation to the proper level beneath the skin surface to render spinal tissue healing or relief from pain.

Handheld roller massage apparatus includes hollow spherical contact orbs that are air-filled and have two relief valves. The design provides for perceived inflation air pressure of about 8-12 pounds per square inch inside each contact orb, where the relief valves hold air until about 8 pounds per square inch and then slowly release air after 8 pounds to yield a large release of air pressure at 12 or more pounds per square inch. When massage pressure is released, the relief valves allow air to return inside the orb to re-inflate the orb. The net result is that hollow spherical contact orbs mechanically act as elastomeric balls filled to 8-12 pounds per square inch of air pressure, with sudden pressure drop off at 12 pounds per square inch. Applicants have determined that contact orbs with this range of perceived inflation pressure deliver tissue massage and stimulation to the proper level beneath the skin surface to render spinal tissue healing or relief from pain.

Each contact orb is mounted to the support rod using two T-washers. Each T-washer is a bushing member integral with a washer member to form a bushing/washer member with a T-shaped cross-section. The washer portion of the member forms a hub or retainer plate for two sides of the contact orb. The hub retains the sides of the massaging orb and prevents side deflection or deformation resulting from downward pressure being applied from the person using the roller massage apparatus, thereby forcing all deflection of the contact orb to occur in the tip of the contact orb. Applicants have determined that orbs that only deflect at the tip deliver tissue massage and stimulation to the proper level beneath the skin surface to render spinal tissue healing or relief from pain.

The exterior of each contact orb is made of fabric that yields enough friction or traction between the contact orbs and the patient's clothing or skin to force the contact orbs to rotate as the roller massage apparatus is rolled along a target area of the patient's body. The fabric is as elastic and resilient as the thin walled semi-rigid resilient material just beneath it so that the overall elastic modulus of the contact orb is not affected. The fabric is of a type that soft and comfortable to the touch against human skin. The exterior fabric also may be removed for washing and then remounted to the contact orb for massage use.

### BRIEF SUMMARY OF THE INVENTION

It is an aspect of this invention to provide a handheld roller massage apparatus with two handles and at least two contact orbs mounted longitudinally and concentrically in series along a rigid cylindrical metal tube or support rod where each handle and contact orb can be individually adjusted to any location along the support rod.

It is an aspect of each contact orb to have a spherical size range specially designed to mechanically penetrate certain exterior tissue layers on either side of the spine to a certain distance to reach muscle tissue beneath the exterior layers, thereby providing a deep tissue massage of muscle tissue on either side of the spine.

It is an aspect of each contact orb to have a spherical shell that is elastomeric and resilient so that it deforms under pressure specially and only with the sufficient pressure required to penetrate certain exterior tissue layers on either side of the spine to reach muscle tissue beneath the exterior layers, thereby providing a deep tissue massage of muscle tissue on either side of the spine.

It is an aspect of each contact orb to comprise a hollow sphere that is filled with air to a certain range of perceived inflation pressure so that the contact orb deforms under pressure specially and only with the sufficient pressure required to penetrate certain exterior tissue layers on either side of the spine to reach muscle tissue beneath the exterior layers, thereby providing a deep tissue massage of muscle tissue on either side of the spine. At the same time, the hollow sphere must collapse under higher pressures to prevent injury or damage to tissue beneath the target area.

It is an aspect of each contact orb to be mounted to support rod with two specially designed T-washers, one mounted on each of two opposite ends of a contact orb. It is an aspect of each T-washer for the exterior hub structure or washer to be integral with and rigidly connected to the bushing structure, thereby forming the T-shaped cross-section of the T-washer member.

It is an aspect of each T-washer to form a precise interference fit connection with the support rod that allows easy adjustment and movement of the contact orb along the support rod by the user, while also providing a no-slip rigid connection with the support rod when the massage apparatus is being used to massage a target area of a human body. It is an aspect of each T-washer to function as a bushing with a precise interference fit in the pivotal connection between a contact orb and the support rod noting that contact orbs should move along the support rod for adjustment, but hold a tight to the support rod during a massage use.

It is an aspect of each T-washer to function as an exterior hub or rigid exterior support wall on two opposite sides of a contact orb to provide support on each end and prevent the collapse of the contact orb from its spherical shape while under massage pressure from the user, so that the contact orb deforms under pressure specially and only under sufficient pressure required to penetrate certain exterior tissue layers on either side of the spine to reach muscle tissue beneath the exterior layers, thereby providing a deep tissue massage of muscle tissue on either side of the spine.

It is an aspect of each contact orb to include a fabric exterior that is not rubber or plastic. Fabric provides the coefficient of static friction in the range that is most suitable for deep tissue roller massage. The optimal range allows enough friction between the contact orbs and the clothing or skin of the patient to cause the contact orbs to roll or rotate as the roller massage apparatus is rolled along the spine or other target area of the patient. It is an aspect of the fabric exterior to feel soft and comfortable against the skin. It is an aspect of the fabric exterior to be removable for washing and then re-mounted to the contact orb.

### BRIEF DESCRIPTION OF THE DRAWINGS

FIG. 1 is a perspective view of adjustable handheld roller massage apparatus with fabric-covered resilient air-filled spherical contact orbs.

FIG. 2 is a front elevation view of adjustable handheld roller massage apparatus with fabric-covered resilient air-filled spherical contact orbs.

FIG. 3 is a side elevation view of adjustable handheld roller massage apparatus with fabric-covered resilient air-filled spherical contact orbs

FIGS. 4 and 5 are front elevation views of adjustable handheld roller massage apparatus with fabric-covered resilient air-filled spherical contact orbs depicting the full adjustability of the contact orbs and handle grips.

FIG. 6 is a cross sectional view of adjustable handheld roller massage apparatus with fabric-covered resilient air-filled spherical contact orbs.

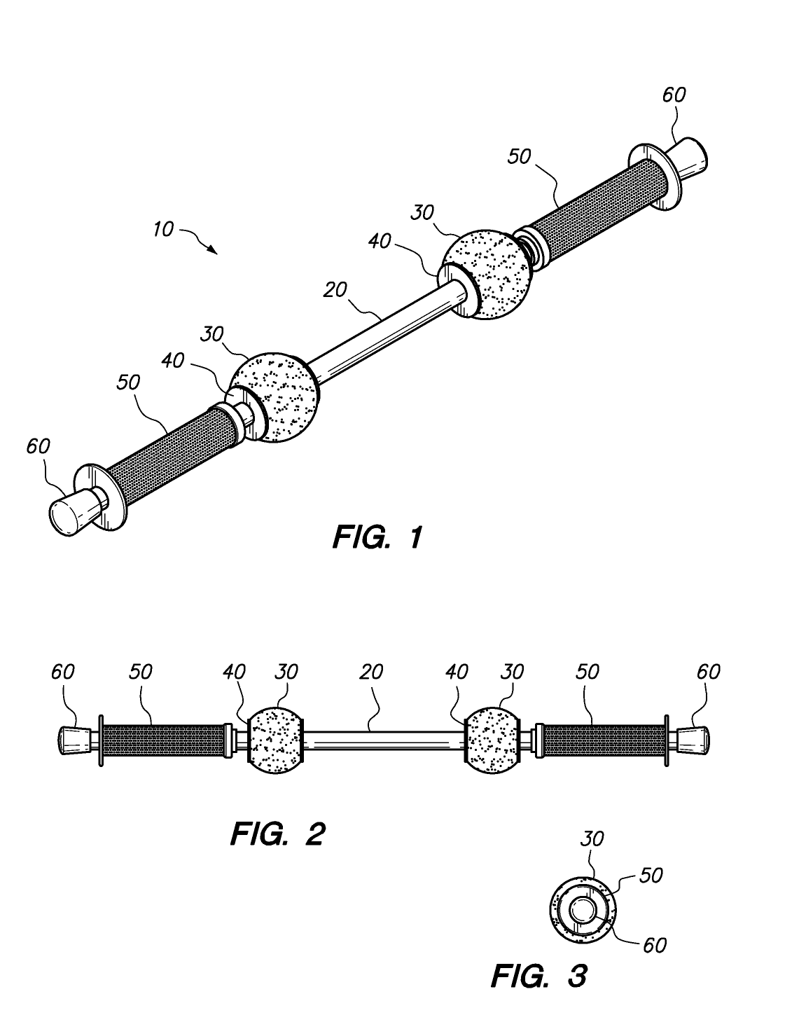

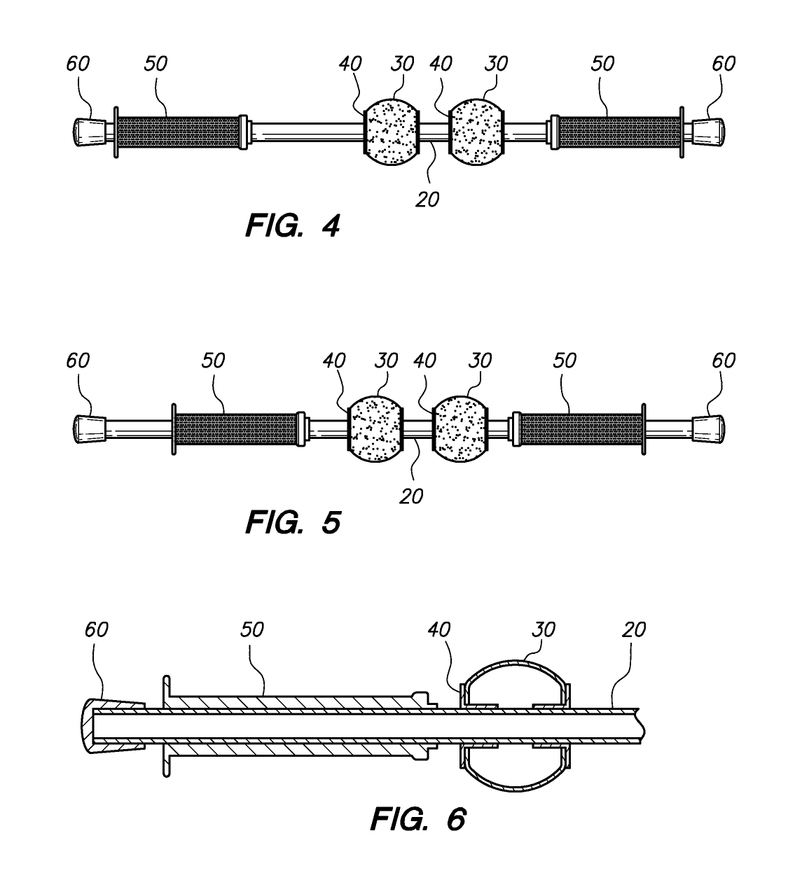

### DEFINITION LIST

| Term | Definition |
|---|---|
| 10 | Adjustable Handheld Roller Massage Apparatus with Fabric- |
| | Covered Resilient Air-Filled Spherical Contact Orbs |
| 20 | Rigid Cylindrical Metal Tube |
| 30 | At Least Two Contact Orbs |
| 40 | T-Washer |
| 50 | Handle Grip |
| 60 | End Cap |

### DETAILED DESCRIPTION OF THE INVENTION

Adjustable handheld roller massage apparatus with fabric-covered resilient air-filled spherical contact orbs 10 comprises a rigid cylindrical metal tube 20. Rigid cylindrical metal tube 20 is a straight rigid cylindrical tube made of metal that is about 1.5-4 feet long and about 0.25-2 inches in outer diameter. Rigid cylindrical metal tube 20 is thin-walled and hollow so that its weight is kept to a minimum. Rigid cylindrical metal tube 20 is made of metal so that it remains rigid and free from deflection or deformation under 200 pounds or less of lateral pressure on each end. The end plan view of rigid cylindrical metal tube 20 is circular.

All components: at least two contact orbs 30, T-washers 40, handle grips 50, and end caps 60 are center-mounted on the rigid cylindrical metal tube 20 so that, in end plan view, at least two contact orbs 30, T-washers 40, handle grips 50, end caps 60, and rigid cylindrical metal tube 20 are mounted concentrically with each other. In end plan view, all components: at least two contact orbs 30, T-washers 40, handle grips 50, and end caps 60 share the same center point.

Adjustable handheld roller massage apparatus with fabric-covered resilient air-filled spherical contact orbs 10 further comprises at least two contact orbs 30. A minimum of two contact orbs 30 are required so that one contact orb 30 may contact tissue on each side of the spine. At least two contact orbs 30 are semi-rigidly mounted to rigid cylindrical metal tube 20 through a mounting socket in the center of each contact orb 30. The mounting socket is two mounting holes in the surface of contact orb 30, each at opposite ends on the center axis. Each mounting hole is reinforced with a special T-washer member 40, as described below. Together, mounting holes and T-washers function to help yield the semi-rigid mount and a relief valves of all contact orbs 30. Rigid cylindrical metal tube 20 is inserted through the mounting holes and T-washers to accomplish the semi-rigid mount of all contact orbs 30 on rigid cylindrical metal tube 20. The orb mount is semi-rigid because it is a rigid connection during massaging and a non-rigid slideable connection during adjustment of the contact orb location. When rigid, this mount allows contact orbs 30 to rotate evenly along the massage surface as rigid cylindrical metal tube 20 is rolled along the massage surface. When slideable, contact orbs 30 may be adjusted and moved to any location along the longitudinal axis of the rigid cylindrical metal tube 20.

At least two contact orbs 30 are hollow spheres or balls about 2.5 to 3 inches in outer diameter. Spheres are the optimal shape because spheres may be rolled like a wheel on the back while delivering the required massage technique along the rolled target area. Spheres of this size are optimal because they are sized to penetrate the distance of superficial tissue above targeted muscles and ligaments around the spine in order to reach the lower muscles and ligaments without penetrating too far to cause pain or reach tissue layers deeper than those of the target muscles and ligaments.

At least two contact orbs 30 are made of thin-walled semi-rigid resilient material so that all contact orbs 30 deflect or deform under massage pressure and return to their original spherical shape after massage pressure is released. At least two contact orbs 30 have an elastomeric bias towards a complete rounded sphere-shape. Thin-walled semi-rigid resilient material must be rigid enough to resist deformation or deflection at lower massage pressures so that all contact orbs 30 may hold their concave shape to penetrate to the targeted lower tissue layers. If deformation occurs too readily, contact orbs 30 would deflect and deform from convex to a flat or concave layer that only affects surface tissue. On the other hand, semi-rigid resilient material must be flexible enough to deform when necessary. If deformation does not occur above a maximum threshold level of massage pressure, then an overzealous massage could cause the contact orbs 30 to remain convex and penetrate too deeply to cause pain or damage to tissue below the targeted muscles and ligaments.

An object of the invention is to loosen and retrain tight muscles and ligaments around the spine, but not to affect tissue below these areas. Thus, the elastic modulus of the thin-walled semi-rigid resilient material of the contact orbs must be within a range to yield the above characteristics. Thin-walled semi-rigid resilient material is rubber, synthetic rubber, plastic, or fabric material that is air-impermeable and has the required resilient or elastomeric qualities. The elastic modulus of a resilient or elastomeric material on the source market is usually varied according to the thickness of the resilient or elastomeric material. The thickness of resilient or elastomeric material can range from about one sixteenth to one half of an inch.

At least two contact orbs 30 are hollow and filled with air to a perceived pressure of about 8-12 pounds per square inch. Contact orbs 30 made of hollow spherical thin-walled semi-rigid resilient material inflated with air to a perceived air pressure of 8 pounds per square inch or more are rigid enough to resist deformation or deflection at lower massage pressures so that at least two contact orbs 30 may penetrate to the targeted lower tissue layers. Contact orbs 30 with a perceived inflation pressure of less than this amount, allow deformation of the orb to occur too readily, causing at least two contact orbs 30 to deflect and deform from convex to a flat layer that only affects surface tissue. On the other hand, contact orbs 30 with a perceived inflation pressure of more than 12 pounds per square inch cause a problematic lack of deformation yielding contact orbs 30 that remain convex and penetrate too deeply to cause pain or damage to tissue below the targeted muscles and ligaments.

In order to attain this exact range of perceived inflation pressure, at least two contact orbs 30 further comprise two relief valves, one each at opposite ends of contact orb 30, on center. A relief valve comprises a mounting hole in the contact orb 30 and a T-washer 40. As stated above, contact orbs 30 are mounted to rigid cylindrical metal tube 20 through two mounting holes, each mounting hole reinforced by a T-washer 40. A T-washer 40 is permanently attached around each mounting hole in the contact orb 30, so that each mounting hole in the orb is concentric with the hole in the attached T-washer. Rigid cylindrical metal tube is inserted through the hole of each T-washer 40 in order to mount a contact orb 30.

With this design, the release of air from the relief valve occurs as an “air leak” between the thin-walled semi-rigid resilient material of the contact orb 30 and the T-washer 40. A T-washer 40 is permanently attached around each mounting hole in the contact orb 30 in a certain way so that air leaks through the connection at higher pressures and air is allowed to return through the connection after the release of massage pressure. Any connection method or additional structure, such as a conventional valve, may be used to yield a relief valve. In best mode, the relief valve function is accomplished without additional structure in order to reduce the number of components and the cost of manufacture. In best mode, a glue pattern is applied to the inside surface of the annulus member (see below) around the hole of a T-washer 40 with one or more small gaps in the glue pattern and permanently glued around the mounting hole on the exterior surface of the contact orb 30. The gap(s) in the glue pattern allow air to escape through at higher pressure and allow the ingress of air back inside the contact orb 30 when massage pressure is released. At least two contact orbs 30 return to their original spherical shape after massage pressure is released.

Adjustable handheld roller massage apparatus with fabric-covered resilient air-filled spherical contact orbs 10 further comprises two T-washers 40 per contact orb 30. Thus, there are a minimum of 4 T-washers 40 per adjustable handheld roller massage apparatus with fabric-covered resilient air-filled spherical contact orbs 10. A T-washer 40 is a rigid non-permeable annulus-shaped or washer-shaped member integral with or rigidly attached to a rigid non-permeable hollow cylindrical member. The inner diameter of the hollow cylinder member is the same as the inner diameter of the annulus member. One end of the hollow cylinder member is integral with or rigidly attached to the inner diameter of the annulus so that the longitudinal axis of the cylinder is perpendicular to the plane of the annulus. Hollow cylinder member and annulus member have an impermeable connection, uni-body, or seam. The longitudinal center cross-section of T-washer 40 resembles a T-shape, hence the name “T-washer”. T-washer 40 is rigid, sturdy, and not permeable member.

In best mode, in order to attach a T-washer 40 to a contact orb 30, glue is applied around the hole in the T-washer on the lower surface of the annular member, with the T-shape in upright position. The axis of the hole in the T-washer is coincident with the leg of the T-shape. T-washer 40 is then pressed onto the outer surface of the contact orb 30, with the hole in the T-washer 40 concentric with the mounting hole on the contact orb 30. The process is repeated for the other mounting hole on the contact orb 30 with another T-washer 40. At this point, the contact orb 30 is fully assembled.

The hole in the annulus member of T-washer 40 is circular and is located in the center of the annulus member. The hole in the annulus member of T-washer 40 is precisely sized to marry with the circular outer diameter of the rigid cylindrical metal tube 20. There is an exact interference fit between these members. The outer diameter of rigid cylindrical metal tube 20 is the same size as or just slightly smaller than the inner diameter of the hole in the T-washer.

This interference fit yields the characteristics of the semi-rigid mounting of at least two contact orbs 30 to rigid cylindrical metal tube 20. When there is just a slight amount of massage pressure applied by the user of the device by pressing down on the handle grips 50, this causes the rigid cylindrical metal tube 20 to press down on the inner diameter of the T-washers 40, causing the T-washers 40 to hold rigid with the rigid cylindrical metal tube 20. Functionally, this allows the at least two contact orbs 30 to rotate along with and as the rigid cylindrical metal tube 20 rotates. When massage pressure is released, the T-washers 40 may be slid along the rigid cylindrical metal tube 20 to match the exact particular separation distance of the deep tissue target muscles and ligaments on both sides of the patient's spine. To achieve this interference fit, the inner diameter of the circular hole in T-washer 40 should be about 0.001-0.0750 of an inch smaller than the outer diameter of rigid cylindrical metal tube 20.

The annulus member of T-washer 40 functions as an exterior hub or rigid exterior support wall at opposite sides of a contact orb 30. As stated, there are two T-washers 40 per contact orb 30. The outer diameter of the annulus member of T-washer is about one quarter to one half that of a contact orb 30. In this way, T-washers 40 provide support on each end of a contact orb 30 to prevent the collapse of the contact orb 30 from its spherical shape while under massage pressure from the user. T-washers 40 force contact orbs 30 to deform under pressure specially by retaining the sides of the massaging orb 30 and preventing side deflection or deformation resulting from downward pressure being applied from the person using the roller massage apparatus 10, thereby forcing all deflection of the contact orb 30 to occur in the tip of the spherical contact orb 30. Applicants have determined that spherical contact orbs 30 that only deflect at the tip deliver tissue massage and stimulation to the proper level beneath the skin surface to render spinal tissue healing or relief from pain.

Adjustable handheld roller massage apparatus with fabric-covered resilient air-filled spherical contact orbs 10 further comprises two handle grips 50 pivotally mounted to rigid cylindrical metal tube 20. Handle grip 50 is an open-ended cylindrical member about 3-8 inches long with a soft elastomeric exterior surface. Soft elastomeric exterior surface is a soft resilient surface for the user of the massage device to hold onto. The outer diameter of soft elastomeric exterior surface is sized to fit comfortably in the average human's hand.

The inner diameter of handle grip 50 is precisely sized to marry with the circular outer diameter of the rigid cylindrical metal tube 20. There is an exact slip fit between these members. The outer diameter of rigid cylindrical metal tube 20 is slightly smaller than the inner diameter of the handle grip 50 so that there is about 0.001-0.050 inches of air space between these members.

This slip fit yields the characteristics of the pivotal mounting of two handle grips 50 to rigid cylindrical metal tube 20. Pivotal mounting allows the rigid cylindrical metal tube 20 to freely rotate inside handle grips 50 as the user rolls the massage device over the target area. Thus, the friction between rigid cylindrical metal tube 20 and the handle grips 50 is less than the friction between T-washers and rigid cylindrical metal tube 20. However, the slip fit must not be so loose as to allow handle grips 50 to move along the longitudinal axis of the rigid cylindrical metal tube 20 during the massage.

As a result, handheld roller massage apparatus 10 is completely adjustability in that each contact orb 30 and each handle grip 50 may be individually adjusted to any position along the length of a rigid cylindrical metal tube 20. Complete adjustability is required to adjust the position of contact orbs 30 to match the actual and specific separation distance of the patient's deep muscle tissue beneath the skin adjacent to the patient's spine and also to adjust to the specific separation distance of the person's hands delivering the massage to the desired distance to allow for the massager to more comfortably apply the required heavy pressure to massage and stimulate the target muscle tissue. Adjustability of the orbs provides the ability to target the correct areas regardless of the particular patient's spine size. Adjustability of the handles provides the ability for the massager to comfortably apply enough pressure to reach deep tissue regardless of the person's size. Without these capabilities, to a certain degree, each handheld roller massage apparatus 10 needs to be specially sized and manufactured for each patient and also for each person delivering the massage in order to properly target the specific areas and reach deep tissue massage and stimulation along the spine, as does this invention.

The exterior of at least two contact orbs 30 is made of a woven or non-woven fabric. Fabric, as opposed to rubber or plastic, provides enough friction or traction between the contact orbs 30 and the patient's clothing or skin to force the contact orbs to rotate exactly along with the rigid cylindrical metal tube 20, as the handheld roller massage apparatus 10 is rotated. Plastic and rubber materials do not have a large enough coefficient of friction to insure that the orbs rotate with the translational motion of the roller massage apparatus 10. Additionally, plastic and rubber materials do not feel as comfortably next to the skin as compared to fabrics. Woven or non-woven fabric exterior fabric may be removed for washing and then remounted to the contact orb 30 for massage use. The exterior fabric is as elastic and resilient as the thin walled semi-rigid resilient material just beneath it so that the overall elastic modulus of the contact orb is not affected by the exterior fabric.

Adjustable handheld roller massage apparatus with fabric-covered resilient air-filled spherical contact orbs 10 further comprises two end caps 60. End cap 60 is a soft or padded elastomeric cylindrical member closed on one end. The inner diameter of cylindrical member matches the outer diameter of rigid cylindrical metal tube member 20. The open end of cylindrical member is slid onto and over the end of rigid cylindrical metal tube member 20 to form a press fit between these members. End caps are rigidly connected with rigid cylindrical metal tube member 20. One end cap 60 is fitted on each of the two ends of rigid cylindrical metal tube member 20. End caps 60 function to protect the user and patient from the ends of rigid cylindrical metal tube member 20, which could be sharp, abrasive, or uncomfortably to the skin because of its metal character. Also, end caps 60 prevent any foreign matter from entering the interior of the rigid cylindrical metal tube member 20.

What is claimed is:

1. A handheld roller massage apparatus comprising: a rigid cylindrical metal tube; at least two contact orbs; at least four T-washers; two handle grips; and two end caps; wherein,
said rigid cylindrical metal tube is a straight rigid hollow cylindrical tube made of metal that is 1.5-4 feet long and 0.25-2 inches in outer diameter,
said at least two contact orbs, said at least four T-washers, said two handle grips, and said two end caps are center-mounted on said rigid cylindrical metal tube so that in end plan view, said at least two contact orbs 30, said at least four T-washers 40, said two handle grips 50, said two end caps 60, and said rigid cylindrical metal tube 20 are mounted concentrically with each other,
said at least two contact orbs are each sphere-shaped hollow balls 2.5-3 inches in outer diameter made of elastomeric or resilient material that deflects or deforms under pressure but returns back to its original shape when the pressure is released,
each of said at least four T-washers is a rigid non-permeable annulus-shaped or washer-shaped member integral with or rigidly attached to a rigid non-permeable hollow cylindrical member with open ends, where the inner diameter of said hollow cylindrical member is the same as the inner diameter of said annulus member and one end of said hollow cylindrical member is integral with or rigidly attached to the inner diameter of said annulus member so that the longitudinal axis of said hollow cylindrical member is perpendicular to the plane of said annulus member,
each of said at least four T-washers is rigidly attached to opposite sides, at the center, of each of said at least two contact orbs, with the cylindrical member side of each of said T-washer directly facing each of said at least two contact orbs,
thereby creating a mounting socket or hole in each of said at least two contact orbs defined by the hollow cylindrical members of two of said at least four T-washers, one at opposite sides of each of said at least two contact orbs,
the inner diameter of each of said at least four T-washers is essentially the same as the outer diameter of said rigid cylindrical metal tube,
said at least two contact orbs are semi-rigidly mounted to said rigid cylindrical metal tube where one end of said rigid cylindrical metal tub is inserted through said mounting socket of each of said at least two contact orbs to form an interference fit between these members so that each of said at least two contact orbs may be relocated to another position along said rigid cylindrical metal tube when desired but yet each of said at least two contact orbs remains stationary relative to said rigid cylindrical metal tube during operation of said handheld roller massage apparatus,
said annulus members of each of said at least four T-washers are exterior hubs or rigid support walls at opposite sides of each of said at least two contact orbs to support the sides of each of said at least two contact orbs and force deflection or deformation to occur in the tip of each of said at least two contact orbs and not in the sides thereof,
each of said two handle grips is an open-ended cylindrical member 4-8 inches long with outer diameter sized to fit comfortably in the average human's hand, inner diameter slightly larger than the outer diameter of said rigid cylindrical metal tube, and a soft elastomeric exterior surface, and
each of said two handle grips is pivotally mounted to said rigid cylindrical metal tube where one end of said rigid cylindrical metal tube is inserted through the open-ended cylindrical member of each of said two handle grips to form a slip fit between these members so that said rigid cylindrical metal tube may freely rotate without appreciable friction within each of said two handle grips.
